(19) United States
(12) Patent Application Publication
(10) Pub. No.: US 2025/0191006 A1
(43) Pub. Date: Jun. 12, 2025

(54) SYSTEM FOR SUGGESTING DESCRIPTIVE FEEDBACK TO A USER ENGAGED IN AN INTERACTION

(71) Applicant: eBay Inc., San Jose, CA (US)

(72) Inventors: Neeraj Gupta, Milpitas, CA (US); Rishab Lokray, Kirkland, WA (US)

(21) Appl. No.: 18/533,915

(22) Filed: Dec. 8, 2023

(51) Int. Cl. G06Q 30/0201; G06Q 30/0601

(52) U.S. Cl. CPC G06Q 30/0201; G06Q 30/0643

(57) ABSTRACT

A method for suggesting feedback is provided. The method includes determining an interaction between a first and second users, generating a feedback response element, and providing an interactive user interface that lists the feedback response element and a selectable machine learning feedback response element. The method also includes receiving a selection of the selectable machine learning feedback response element and accessing a first feedback associated with the first user where the first feedback has characteristics unique to the first user. Moreover, the method includes automatically generating a second feedback using the first feedback, the second feedback incorporating the characteristics unique to the first user without input from the first user.

### TECHNICAL FIELD

Examples of the present disclosure relate generally to systems for providing feedback and, more particularly, but not by way of limitation, to systems for suggesting feedback to a user based on feedback previously provided by the user.

### BACKGROUND

When a first user and a second user complete an interaction, each user can provide feedback regarding their experience. The interaction can relate to an item exchanged between the first and second users, an interaction with a website that facilitated the interaction, or the interaction itself between the first and second users. Thus, the first user can provide feedback about the second user and the second user can provide feedback about the first user. Feedback relating to the first user can be valuable for other users who have a desire to interact with the first user and engage with the first user. Likewise, feedback relating to the second user can be valuable for other users who have a desire to interact with the second user and engage with the second user. The feedback can also relate to the item or the website.

Nonetheless, in existing systems, users provide limited feedback. To further illustrate, the feedback provided by the first user relating to the second user or to the interaction with the second user may simply be “good,” “acceptable,” “thanks,” or “arrived on time.” Likewise, the feedback provided by the second user regarding the first user or relating to the interaction with the first user may be “good,” “thanks,” or “my product arrived safely.” In other instances, the first user may not provide any type of feedback, the second user may not provide any type of feedback, or neither the first user nor the second user may provide any type of feedback.

In instances where a reputation of a user is important in order to allow the user to increase interactions, feedback can be useful to enhance the reputation of the user. However, if the feedback is minimal, such as “good” or “thanks,” this type of feedback does not, or at best does very little, to enhance the reputation of the user. Similar problems exist if no feedback is provided.

A third user may desire to interact with the first user or the second user. When a third user desires to interact with either the first user or the second user, feedback that relating to the first user or the second user or indicates the interaction was “good,” “arrived on time” or “my product arrived safely” will not provide a suitable metric that the third user can use to decide if they should interact with either the first user or the second user. As such, the third user may decide not to interact with the either the first user or the second user or assume that since little feedback exists, interactions with either the first user or the second user may not be worth the effort.

### BRIEF DESCRIPTION OF THE DRAWINGS

Various ones of the appended drawings merely illustrate examples of the present disclosure and should not be considered as limiting its scope.

FIG. 1 is a network diagram illustrating a network environment suitable for suggesting feedback to a user based on feedback previously provided by the user, according to some examples.

FIG. 2 is a method for receiving feedback from a user is shown, according to some examples.

FIGS. 3-8 illustrate an interactive user interface, according to some examples.

FIG. 9 illustrates a method illustrates a method 900 for suggesting feedback to a user using machine learning, according to some examples.

FIGS. 10-17 illustrate an interactive user interface, according to some examples.

FIG. 18 is a block diagram illustrating architecture of software used to implement social network-initiated listings, according to some examples.

FIG. 19 shows a machine as an example computer system with instructions to cause the machine to implement social network-initiated listings, according to some examples.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples of the inventive subject matter. It will be evident, however, to those skilled in the art, that examples of the inventive subject matter may be practiced without these specific details. In general, well-known instruction instances, protocols, structures, and techniques are not necessarily shown in detail.

Examples relate to a method and system for suggesting descriptive feedback to a user engaged in an interaction. An interactive user interface is displayed to the user that includes suggested tags that the user can rate. The interactive user interface can also provide the option for the user to provide feedback. Here, the user can select an interactive selection element, such as a pill, that can activate a machine learning technique to suggest feedback. Upon selection, previous feedback provided by the user along with the behavior of the user and feedback from other users is accessed in order to suggest feedback that the user can provide for the current interaction.

When the user provided the previous feedback, the user may have used a certain writing style, which can include and refer to a first grammatical style, a first syntax, a first tone, or the like, in the previously provided feedback. The previous feedback can be provided to a machine learning model where the machine learning model can learn the writing style of the user to suggest feedback for the interaction where the suggested feedback is in the writing style of the user. Thus, a first user may have a first writing style while a second user may have a second writing style different from the first writing style. Machine learning can suggest feedback for similar interactions where first suggested feedback for the first user incorporates the first writing style while second suggested feedback for the second user incorporates the second writing style. Moreover, machine learning can incorporate various aspects of the interaction into the suggested feedback and then present the suggested feedback to the user. Machine learning can also incorporate a writing a style, such as a language used by the user when providing previous feedback, such as if the user typically writes in French, Hebrew, Hindi, or the like.

To further illustrate, a user may have completed the purchase of a mobile phone where the user provided feedback having a writing style relating to the purchase of the mobile phone. The writing style can be exclamatory declarative sentences while the feedback can relate to certain features of the mobile phone and interactions between the user and the seller of the mobile phone. For example, the previous feedback can be “Camera is awesome! Battery life is terrible!! Screen resolution is next level! Phone thickness is awful!!” This feedback can be provided to the machine learning model where the machine learning model determines that cameras, battery life, screen resolution, and a thickness of a mobile phone are important to the user. Furthermore, the machine learning model can learn that the writing style of the user involves short, declarative sentences where positive attributes are followed with a single exclamation point while negative attributes are followed with two exclamation points.

When the user purchases a second mobile phone, the machine learning model can provide an interactive user interface that can be presented to the user wherein the interactive user interface asks for feedback relating to a camera of the second mobile phone, battery life, screen resolution, and a thickness of the second mobile phone. The interactive user interface can present these features for feedback based on the previous feedback provided by the user. The user can provide feedback for each of the features listed on the interactive user interface. In this illustration, the user rates each of the battery life of the second mobile phone, the camera, and the phone thickness very high. However, the user rates the screen resolution very low.

The interactive user interface can also include a selectable machine learning feedback response element, such as a pill, that, when selected, causes the machine learning model to suggest feedback to the user in the writing style of the user. When the user selects the pill, the machine learning model can suggest written feedback in the writing style of the user that can incorporate the ratings the user provided for the features listed on the interactive user interface. In this illustration, since the writing style of the user involves short, exclamatory sentences where positive attributes are followed with a single exclamation point while negative attributes are followed with two exclamation points, the machine learning model can suggest the feedback of “Camera is awesome! Battery life is great! Screen resolution is terrible!! Phone thickness is next level!” The user can then modify the suggested feedback or provide the suggested feedback as feedback for the second mobile phone.

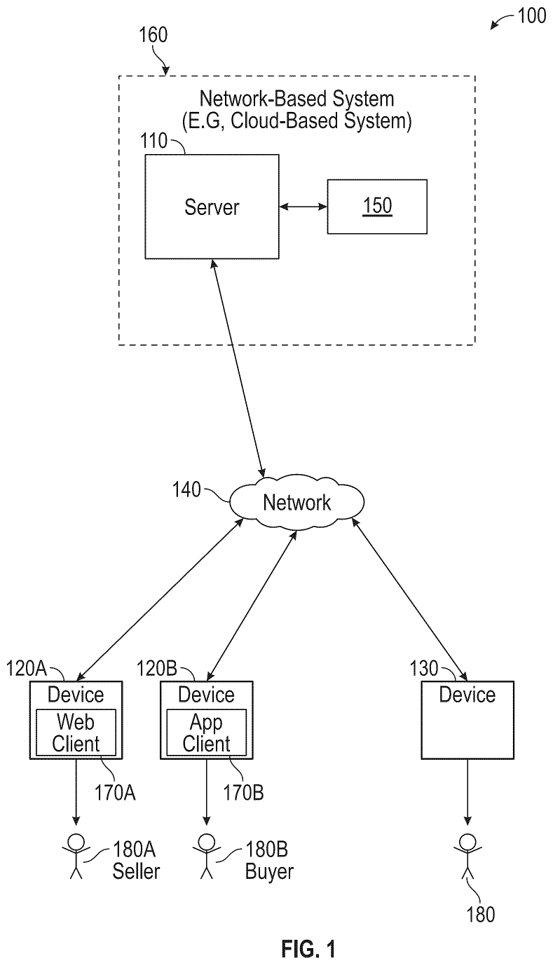

Now turning attention to the Figures, FIG. 1 is a network diagram illustrating a network environment 100 suitable for suggesting feedback that a user has the option of using, according to some examples. The network environment 100 includes a server 110, along with devices 120A, 120B, and 130 communicatively coupled to each other via a network 140. The devices 120A and 120B can be collectively referred to as “devices 120,” or generically referred to as “a device 120.” The server 110 can include a machine learning model 150 and can be part of a network-based system 160.

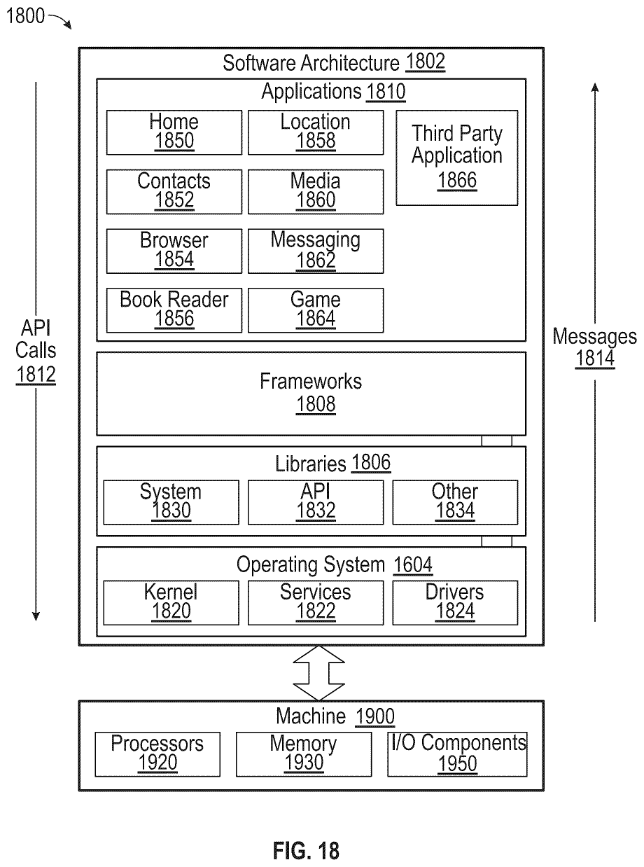

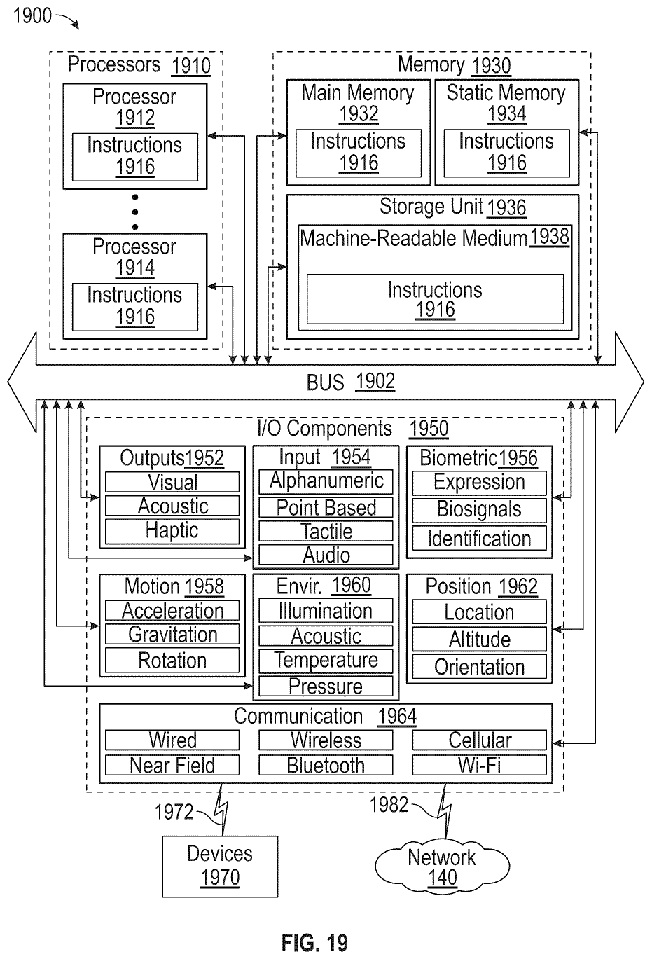

The devices 120 can interact with the 110 using a web client 170A or an app client 170B. The server 110, the devices 120, and the device 130 may each be implemented in a computer system, in whole or in part, as described below with respect to FIGS. 18 and 19.

The server 110, which can be an e-commerce server, can include an electronic commerce application to other machines (e.g., the devices 120A, 120B, and 130) via the network 140. The electronic commerce application can provide a way for users to buy and sell items directly to each other, to buy from and sell to the electronic commerce application provider, or both.

The network 140 may be any network that enables communication between or among machines, databases, and devices (e.g., the e-commerce server 110 and the devices 120 and 130). Accordingly, the network 140 may be a wired network, a wireless network (e.g., a mobile or cellular network), or any suitable combination thereof. The network 140 may include one or more portions that constitute a private network, a public network (e.g., the Internet), or any suitable combination thereof.

The machine learning model 150 can include any type of deep learning algorithm that can perform various natural language processing tasks, such as a large language model. Examples of a large language model can include Chat Generative Pre-trained Transformer (ChatGPT), Pathways Language Model (PaLM), Large Language Model Meta AI (LLaMA), BigScience Large Open-science Open-access Multilingual Language Model (BLOOM), or the like.

The machine learning model 150 can use deep learning to output text through transformer neural networks. The machine learning model 150 can be provided ground rules and then be provided data, such as previous feedback provided from the users 180. In an unsupervised format, the machine learning model 150 can train to develop an understanding of the relationships between a writing style of feedback, attribute of the feedback, and like. The training can be used to create a deep learning neural network that uses a transformation architecture. Text prediction by the transformation architecture can be based on training data provided to the machine learning model 150. The transformation architecture works with chunks of texts, i.e., tokens, within the previous feedback to learn the attributes and the writing style of a user who provided the feedback. Thus, as will be discussed further on, the machine learning model 150 can suggest or mimic feedback to a user, such as the users 180, that the users 180 can provide based on their experience with various transactions. Moreover, the machine learning model 150 can generate an interactive user interface that can list attributes based on feedback provided by a user, where the machine learning model 150 can learn which attributes are important to a user based on feedback previously provided by the user.

The machine learning model 150 can determine what item attributes the users 180 deemed relevant and/or important based on the attributes for which the users 180 previously provided feedback. Furthermore, the machine learning model 150 can determine what item attributes the users 180 deemed relevant and/or important based on based on any commentary the users 180 provided for those attributes. To further illustrate, if one of the users 180 previously purchased a vehicle from a seller, the user 180 may have provided feedback on various attributes the vehicle. The vehicle attributes can include fuel economy, spaciousness, ride comfort, and looks. The user 180 may have provided feedback by way of selecting indicia in an interactive user interface or may have provided feedback in a comments section. The user 180 may have also included comments relating to the looks of the vehicle. This can be provided to the machine learning model 150. Using this feedback, the machine learning model 150 can ascertain that the vehicle attributes of fuel economy, spaciousness, ride comfort, and looks are important to the user 180 using the techniques discussed above.

Moreover, the feedback from the users 180 can include interactions one of the users 180 had with a seller. In the vehicle example illustration, the user 180 may have messaged the seller of the vehicle in order to negotiate a price for the vehicle where the seller offered the vehicle for $10,500 and the user 180 counteroffered for $10,000, which the seller accepted. The chat string can be visualized as follows:

Item Price: X
Chat transcript:
{
[Buyer]: Offered Y for Item. Where Y < X
[Seller]: Accepted the offer.
[Buyer]: Bought item and paid.
}

Here, “X” can refer to $10,500 while Y can refer to “10,000.” Moreover, “Buyer” can refer to the user 180 while the “Seller” can refer to the seller of the vehicle. The chat string above can be provided to the machine learning model 150. Using the chat string, the machine learning model 150 can determine that the original price was $10,500 and that an offer less than $10,500 was made by the user 180. Moreover, the machine learning model 150 can determine that the offer, which was $10,000, was accepted and the user 180 paid for the item. Using machine learning techniques, the machine learning model 150 can infer that the seller is willing to negotiate the price of items being sold by the seller since a lower price was offered and accepted by the seller.

Also shown in FIG. 1 are users 180 associated with the devices 120A, 120B, and 130. Throughout this document, reference may be made to the user 180 and the users 180. It should be noted that the term user 180 and the term users 180 are interchangeable with each other. The user 180 may be a human user (e.g., a human being), a machine user (e.g., a computer configured by a software program to interact with the devices 120 and the server 110), or any suitable combination thereof (e.g., a human assisted by a machine or a machine supervised by a human). The user 180 is not part of the network environment 100, but is associated with the devices 120 and may be a user of the devices 120 (e.g., an owner of the devices 120A and 120B). For example, the device 120 may be a sensor, a desktop computer, a vehicle computer, a tablet computer, a navigational device, a portable media device, or a smart phone belonging to the user 180. The device 130 may be associated with a different user. Moreover, the user 180 can be a buyer or a seller, where each of the buyer and the seller can be associated with any of the devices 120 and 130. Furthermore, the user 180 may be associated with a user account accessible by the electronic commerce application provided by the server 110 via which the users 180 interact with the server 110.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIGS. 18 and 19. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, database, or device, and the functions described herein for any single machine, database, or device may be subdivided among multiple machines, databases, or devices.

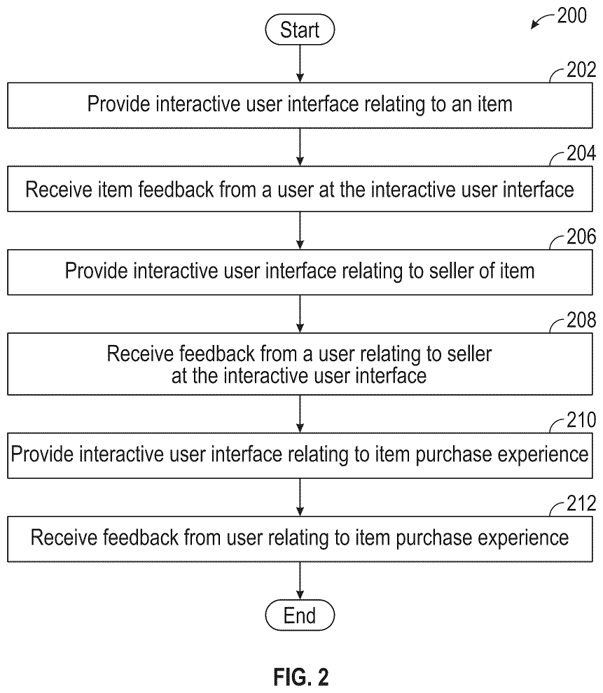

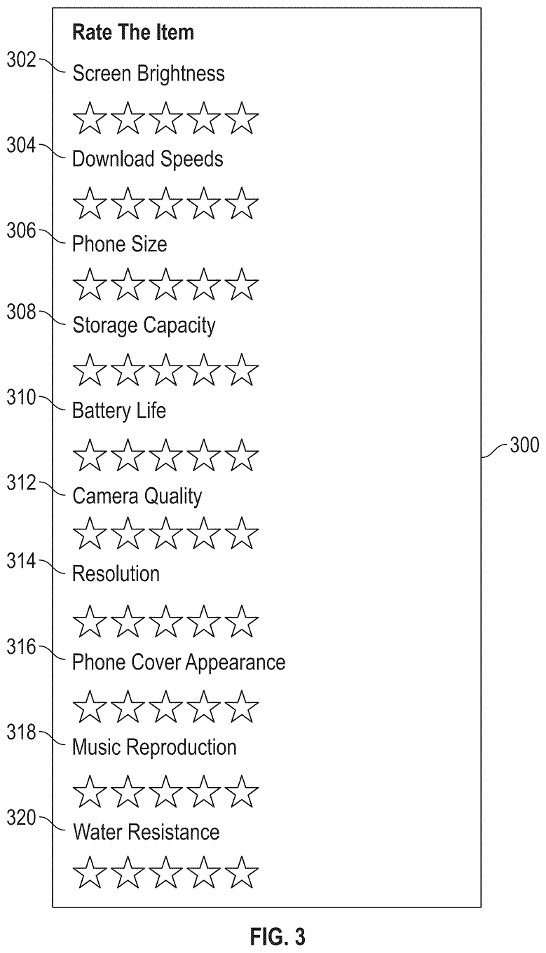

Now making reference to FIG. 2, a method 200 for receiving feedback from a user is shown. Initially, during an operation 202, an interactive user interface is provided to a user when the user has purchased an item. The interactive user interface can list a variety of attributes that are relevant to the item purchased by the user. The attributes can be selected based on feedback provided by other users who have purchased the item, accessing third party sources, such as websites associated with the item that market certain attributes, attributes discussed in articles authored by reviewers of the item, and the like. Moreover, the attributes can be listed based on social media associated with a user to whom the interactive user interface will be presented. To further illustrate, if the user posts on social media several trips to the beach, attributes associated with water resistance, battery life, and durability can be presented.

The attributes can also be listed based on attributes previously selected by the user to which the interactive user interface is being presented. To further illustrate, if the item is a mobile phone, the attributes can relate to a battery life, a size, storage capacity, download speeds, camera quality, or screen resolution, based on attributes for which the user previously provided feedback. In addition, the interactive user interface can include a comments section where the user can provide comments relating to the mobile phone in a writing style unique to the user.

During an operation 204, feedback is received from the user. The feedback can be in the form of ratings assigned to each of the attributes listed in the interactive user interface. Each of the attributes can have a feedback response element, which can allow a user to provide a rating for the attribute associated with the feedback response element. The feedback response element can include a number of selectable elements where selection of a given number of the feedback response selectable elements can correspond to a rating associated with the attribute. Thus, the greater the number of feedback response selectable elements selected, the greater the likelihood that the user likes the associated attribute. Moreover, selection of a feedback response selectable element can indicate that the user values the particular attribute. If a user does not select a feedback response selectable element, this can indicate that the user does not put much weight on or does not value the particular attribute. Therefore, the feedback response selectable element can be removed when feedback is requested from a user at later times. Moreover, after removal, the feedback response selectable element can be provided again based on subsequent feedback received from the user or other users.

For example, and referred to herein as the “first example,” a user has just purchased a mobile phone. During the operation 202, the server 110 can present a user interface 300 to the user 180B at the device 120B, which includes a screen brightness attribute 302, a download speed attribute 304, a phone size attribute 306, and a storage capacity attribute 308. A battery life attribute 310, a camera quality attribute 312, and a resolution attribute 314 are also presented at the user interface 300. Furthermore, a phone cover appearance attribute 316, a music reproduction attribute 318, and a water resistance attribute 320 are presented at the user interface 300. In the first example, the attributes 302-320 were selected based on feedback provided by other users who purchased the mobile phone and marketing gleaned from third party websites. The feedback provided by other users who purchased the mobile phone and the attributes marketed by third-party websites indicate that the attributes 302-320 were selected and discussed the most.

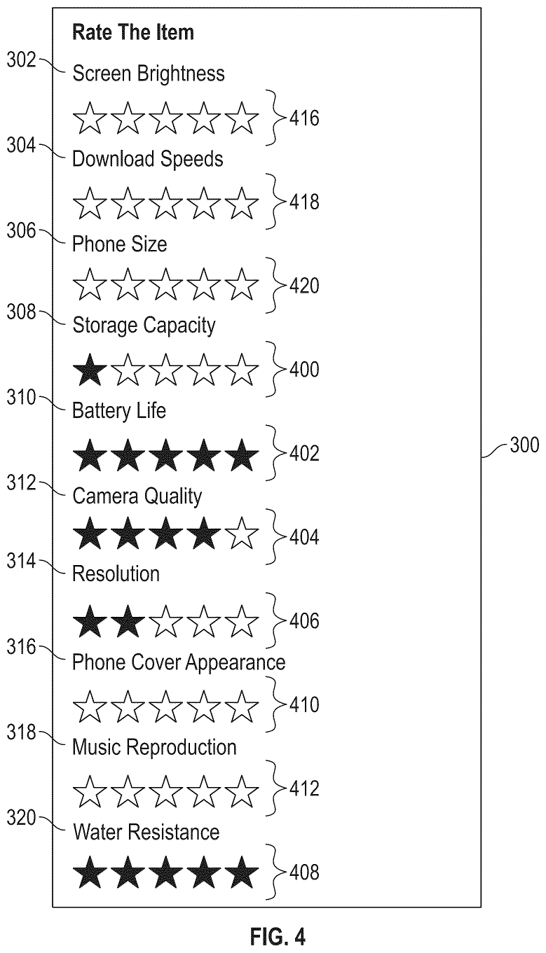

Still sticking with the first example, during the operation 204, the user 180B provides feedback on the attributes 308-314 and 320. For the storage capacity attribute 308, as shown in FIG. 4, the user 180B selected one feedback response selectable element 400 associated with the storage capacity attribute 308 while the user 180B selected five feedback response selectable elements 402 associated with the battery life attribute 310. Additionally, the user 180B selected four feedback response selectable elements 404 associated with the camera quality attribute 312 and two feedback response selectable elements 406 associated with the resolution attribute 314. The user 180B also selected five feedback response selectable elements 408 associated with the water resistance attribute 320. Furthermore, the user 180B did not select any feedback response selectable elements 410-420, which can correlate to the attributes 302-306 and 316 having little importance to the user 180B.

Returning to FIG. 2 and the method 200, after the operation 204, an operation 206 is performed where an interactive user interface is provided to the user relating to the seller of the item. The interactive user interface can list a variety of attributes that can relate to a seller of the item purchased by the user. The attributes can be selected based on feedback provided by other users who have purchased items from the seller, accessing third party sources, or the like. The attributes can include the accuracy of an item description provided by the seller, shipping costs charged by the seller, and the speed with which the seller ships items. Attributes relevant to the seller can also include communication capabilities of the user, such as whether or not the seller is responsive to buyer inquiries along with the friendliness and the courteousness of the seller.

During an operation 208, feedback is received from the user. The feedback can be in the form of ratings assigned to each of the attributes listed in the interactive user interface as discussed above with reference to the operation 204. Each of the attributes can have a feedback response element, which can allow a user to provide a rating to the attribute associated with the feedback response element. The feedback response element can include a number of selectable elements where selection of a given number of the feedback response selectable elements can correspond to a rating associated with the attribute. Thus, the greater the number of feedback response selectable elements selected, the greater the likelihood that a user likes the associated attribute. Moreover, selection of a feedback response selectable element can indicate that the user values the particular attribute. If a user does not select any of the feedback response selectable elements, this can indicate that the user does not value the particular attribute. While the operations 206 and 208 are described as occurring after the operations 202 and 204, the operations 206 and 208 can be performed before the operations 202 and 204 or contemporaneously with the operations 202 and 204.

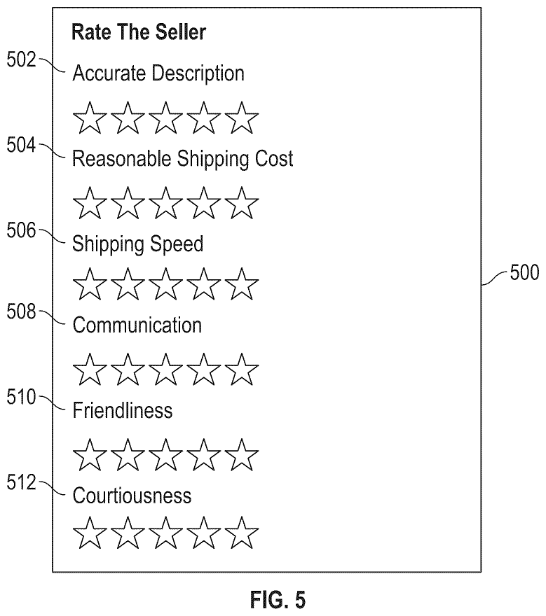

Returning to the first example and FIG. 5, during the operation 206, the server 110 can present the user interface 500 to the user 180B at the device 120B, which can include an accurate description attribute 502, a reasonable shipping cost attribute 504, and a shipping speed attribute 506. The user interface 500 can also include a communication attribute 508, a friendliness attribute 510, and a courteousness attribute 512. In the first example, the attributes were selected and listed based on feedback provided by other users who have interacted with the seller. Thus, the other users have provided feedback for the seller relating to how well the seller previously described items, how much the seller charged for shipping the items, and how quickly the other users received items from the seller, i.e., the seller immediately sent the item or the seller procrastinated on sending the item. Furthermore, the other users have provided feedback for the seller relating to how well the seller communicated with the other users, i.e., was very prompt to reply, and how friendly and courteous the seller was, i.e., the seller was easy to deal with and was not mean when communicating with the other users. Further examples can include the willingness or unwillingness of a seller to accept counteroffers on items.

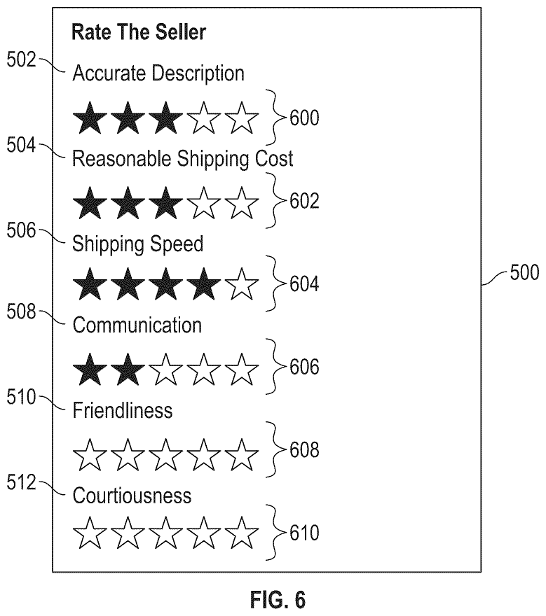

In the first example, during the operation 208, the user 180B provides feedback for the accurate description attribute 502, the reasonable shipping cost attribute 504, the shipping speed attribute 506, and the communication attribute 508, as shown in FIG. 6. In particular, the user 180B selected three feedback response selectable elements 600 associated with the accurate description attribute 502 and three feedback response selectable elements 602 associated with the reasonable shipping cost attribute 504. Additionally, the user 180B selected four feedback response selectable elements 604 associated with the shipping speed attribute 506 and two feedback response selectable elements 606 associated with the communication attribute 508. Furthermore, the user 180B did not select any feedback response selectable elements 608 and 610, which can correlate to the attributes 510 and 512 having little importance to the user 180B.

Turning attention back to FIG. 2, during an operation 210, a user interface that allows the user to provide feedback relating to the item purchase experience is provided. The user interface can include an area within which the user can provide comments regarding the item purchase experience. The item purchase experience can include feedback relating to the product along with the experience the user had with the seller. During an operation 212, the feedback provided by the user is received. While the operations 210 and 212 are described as occurring after the operations 202-208, the operations 210 and 212 can be performed before the operations 202-208 or contemporaneously with the operations 202-208.

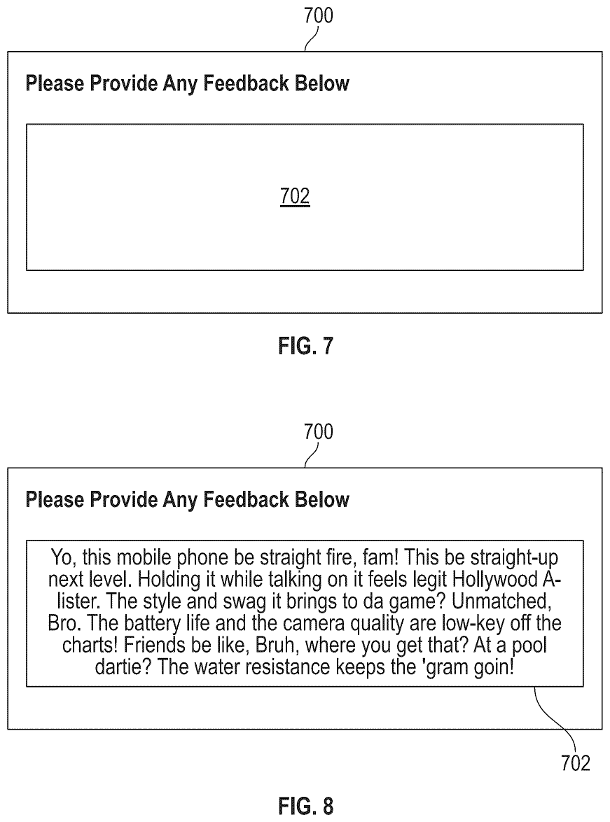

Returning to the first example and FIG. 7, during the operation 212, the server 110 can present the user interface 700, which provides an input field 702 within which the user 180B can provide feedback relating to the experience the user 180B had purchasing the mobile phone. Here, the user 180B provides the following feedback at the input field 702:
“Yo, this mobile phone be straight fire, fam! This be straight-up next level. Holding it while talking on it feels legit Hollywood A-lister. The style and swag it brings to da game? Unmatched, Bro. The battery life and the camera quality are low-key off the charts! Friends be like, Bruh, where you get that? At a pool dartie? The water resistance keeps the ‘gram goin!”

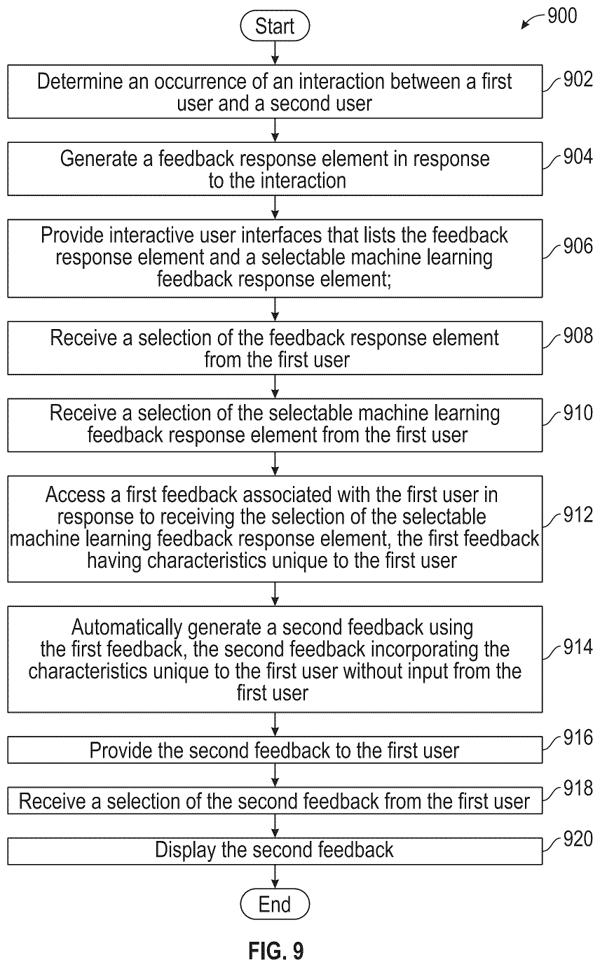

The server 110, via the machine learning model 150, can use the feedback received during the method 200 to suggest feedback to the user at a later time, as discussed with reference to FIG. 9, which illustrates a method 900 for suggesting feedback to a user. Initially, during an operation 902, an occurrence of an interaction between a first user and a second user is determined. The interaction can relate to a sale of an item between the first user and the second user, a service provided by one of the first user or the second user to the other of the first user or the second user, or the like. The server 110 can determine that an interaction has occurred between users in any number of ways, such as if the user 180B purchases an item being sold by the user 180A via the app client 170B. Here, the app client 170B can interact with the server 110, which can serve as a trigger for the server 110 determining that the user 180B is engaging in an interaction. Moreover, in response to the trigger, the server 110 can determine with whom the user 180B is interacting with, such as the user 180A.

After determining that an interaction has occurred, a feedback response element is generated in response to the interaction during an operation 904. In instances when the interaction is the purchase of an item, the feedback response element can be related to an attribute of the item purchased and/or an attribute associated with the seller of the item. The feedback response element can be generated in any number of ways. The feedback response element can be generated based on feedback the user previously provided for similar items the user purchased in the past as detailed above with reference to the method 200, such as the feedback received during the operations 204, 208, and 212. Alternatively, when a first user is purchasing an item, the feedback response element can be generated based on feedback other users previously provided when purchasing the item or a similar item.

To further illustrate, if the interaction in the operation 902 relates to the purchase of a laptop computer by a first user, during the operation 904, a feedback response element can be based on feedback the first user provided when the first user previously purchased a laptop. Alternatively, the feedback response element can be based on feedback provided by second users who have purchased the laptop computer. For example, if the item is a Lenovo™ laptop computer, and other users who have purchased the Lenovo™ laptop computer have provided feedback, the machine learning model 150 can determine what attributes were mentioned in the feedback and assign a feedback response element to attributes mentioned in the feedback. Thus, if a user who previously purchased the Lenovo™ laptop provided the following feedback “I accidently knocked this computer off my kitchen counter and it didn't miss a beat. This computer is very durable,” the machine learning model 150 can generate a feedback response element associated with “durability.”

Moreover, the feedback response element can be generated based on attributes associated with the item. In the Lenovo™ laptop computer example, the machine learning model 150 can look at various attributes of the Lenovo™ laptop computer, such as battery life, weight, and size and generate feedback response elements that relate to battery life, weight, and size. Furthermore, third party sources associated with Lenovo™ laptop computers can be scraped such as a website of the manufacturer of the Lenovo™ computer, websites that provide reviews of laptop computers, or the like. The machine learning model 150 can determine which attributes of the Lenovo™ laptop computer are emphasized from the scraped third party sources as reasons to purchase the computer. These attributes can include screen resolution, processor speed, or the like. The machine learning model 150 can use these attributes to generate feedback response elements during the operation 904.

In addition, the machine learning model 150 can access user engagement history associated with feedback response elements previously generated for the item to determine if a feedback response element should be generated in response to the occurrence of the interaction between the first user and the second user. The user engagement history can indicate that very little feedback was provided for a particular attribute corresponding to a feedback response element. Here, the machine learning model 150 may not generate a feedback response element for that attribute. In the Lenovo™ laptop computer illustration, while screen resolution was an attribute that was emphasized at third party sources and hence presented in the past as a feedback response element, if few other users have provided feedback for the attribute screen resolution via the feedback response element or the user who just purchased the Lenovo™ laptop computer has not provided feedback for this attribute for past computer purchases, then the machine learning model 150 may not generate a feedback response element that includes screen resolution during the operation 904.

The feedback response elements can be generated based on a location of the first user interacting with the second user. In the Lenovo™ laptop example, the first user may be in a location where infrastructure is limited and device download speeds are an important feature. The location determination can be made based on a profile associated with the first user or global positioning coordinates of a device associated with the user. In areas where download speeds are important, the machine learning model 150 can generate a feedback response element associated with the download speed attribute.

As mentioned above, when the interaction is the purchase of an item, the feedback response element can be generated based on an attribute associated with the seller of the item. If the buyer has purchased other items from the seller, regardless of whether or not the item is similar to the item purchased during the interaction determined during the operation 902, the buyer may have provided feedback for attributes regarding the seller as listed above.

In the method 900, once a feedback response element is generated, interactive user interfaces are provided during an operation 906. The interactive user interface can include the feedback response element generated during the operation 904 along with a selectable machine learning feedback response element. When selected by a user, the selectable machine learning feedback response element can automatically generate feedback that includes a writing style unique to the user. The writing styles can relate to a language used by the user when providing previous feedback, such as if the user typically writes in French, Hebrew, Hindi, or the like. As an example of the method 900, and referred to herein as the “second example,” the first user 180B purchases a mobile phone from the user 180A. In the second example, five other users have also purchased a mobile phone from the user 180A similar to the mobile phone purchased by the user 180B. Moreover, five other users have purchased a mobile phone similar to the mobile phone purchased by the user 180B from other sellers.

During the operation 902, the server 110 determines that an interaction has occurred between the user 180A and the user 180B based on the user 180B purchasing the mobile phone from the user 180A. Upon determining that the interaction has occurred, a feedback response element is generated during the operation 904. In the second example, the machine learning model 150 can determine that the user 180B previously purchased a similar mobile phone as discussed above with reference to the method 200 and the first example. In particular, the machine learning model 150 can determine that the user 180B provided input for the attributes 308-314, 320, and 502-508 as previously discussed.

Moreover, the machine learning model 150 can determine that the user 180B did not provide input for the attributes 302-306, 316, 318, 510, and 512 also as previously discussed. The machine learning model 150 also determines that the other five users who purchased similar mobile phones from the user 180A provided feedback for the attributes 316 and 512. The machine learning model 150 also determines that the other five users who purchased similar mobile phones from other sellers provided feedback for the attribute 304. Moreover, in the second example, the user 180B provided feedback relating to the style of the previously purchased mobile phone.

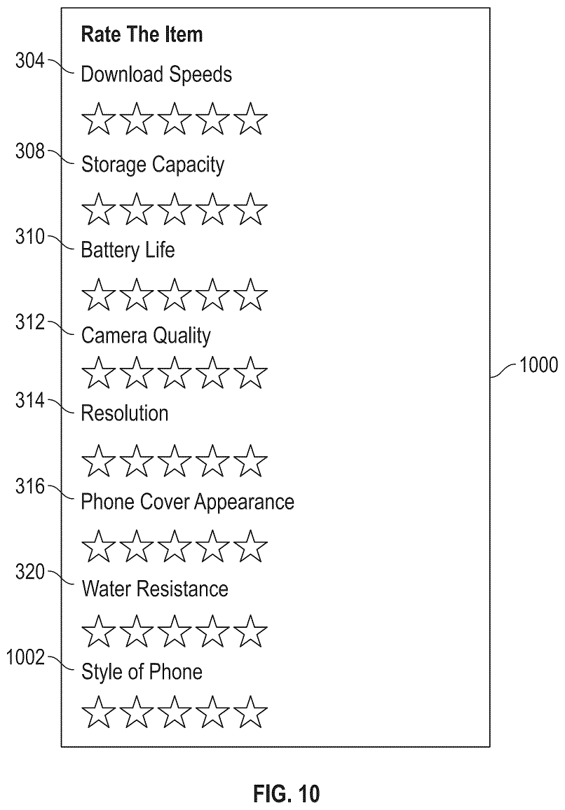

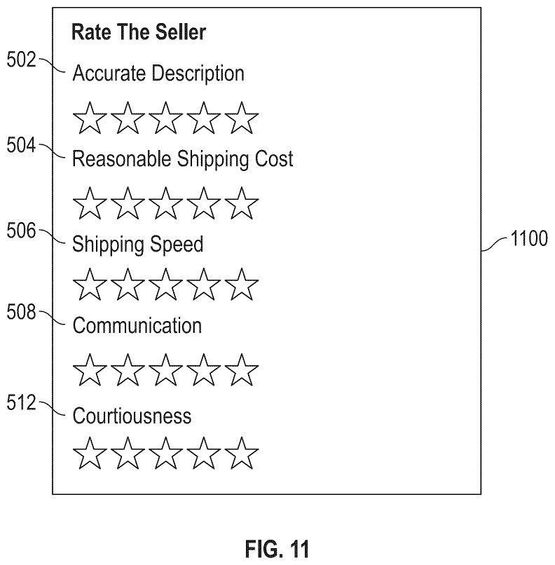

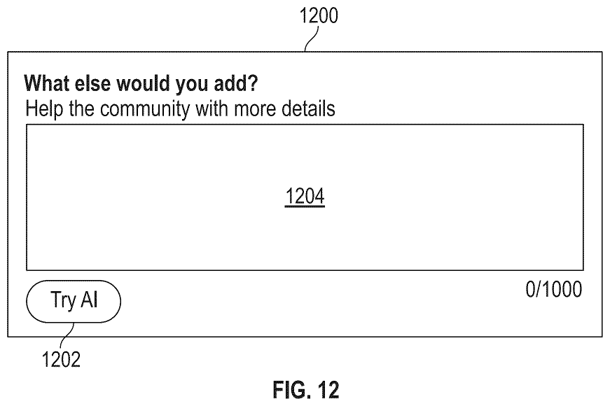

Therefore, in the second example, during the operation 904, the machine learning model 150, in conjunction with the server 110, generates feedback response elements corresponding to the attributes 304, 308-316, 320, 502-508, and 512. A feedback response element can also be generated corresponding to a style of the mobile phone. During the operation 906, the server 110 generates interactive user interfaces 1000-1200 as shown with reference to FIGS. 10-12. The interactive user interface 1000 includes the attributes 304, 308-316, 320 along with a style of phone attribute 1002. The interactive user interface 1100 includes the attributes 502-508 and 512. The interactive user interface 1200 includes a selectable machine learning feedback response element 1202. If the user 180B selects the selectable machine learning feedback response element 1202, the user can provide feedback at input field 1204. If the user 180B selects the feedback response element 1202 a second time, feedback can be generated and suggested to the user 180B.

Returning to FIG. 9 and the method 900, after the interactive user interfaces are provided during the operation 906, a selection of the feedback response element can be received during an operation 908. Furthermore, first and second selections of the selectable machine learning feedback response element can be received during an operation 910. The first selection of the selectable machine learning feedback response element can correspond to a user desiring to provide feedback while the second selection can correspond to the user desiring to have feedback suggested to them using machine learning. Moreover, while selection of the selectable machine learning feedback response element is described as occurring twice to suggest feedback, in examples, engagement of the selectable machine learning feedback response element once can initiate the generation of the feedback using machine learning as described herein.

Upon receiving selections of the feedback response element and the selectable machine learning feedback response element, the method 900 performs an operation 912, where first feedback associated with the first user is accessed in response to receiving the selections in the operations 908 and 910. The first feedback can have characteristics that are unique to the first user, such as a writing style, which can have the characteristics described above, such as with reference to FIG. 8. During the operation 912, the server 110 can access the feedback that was received during the operation 212.

The machine learning model 150 can automatically generate a second feedback in response to receiving a selection of the selectable machine learning feedback response element during an operation 914. Using the techniques described above, the machine learning model 150 can generate the second feedback such that the second feedback includes characteristics that are unique to the user who selected the selectable machine learning feedback response element. If the user previously used short, declarative sentences where positive attributes are followed with a single exclamation point while negative attributes are followed with two exclamation points, the machine learning model 150 can generate a second feedback that uses short, declarative sentences where positive attributes are followed with a single exclamation point while negative attributes are followed with two exclamation points.

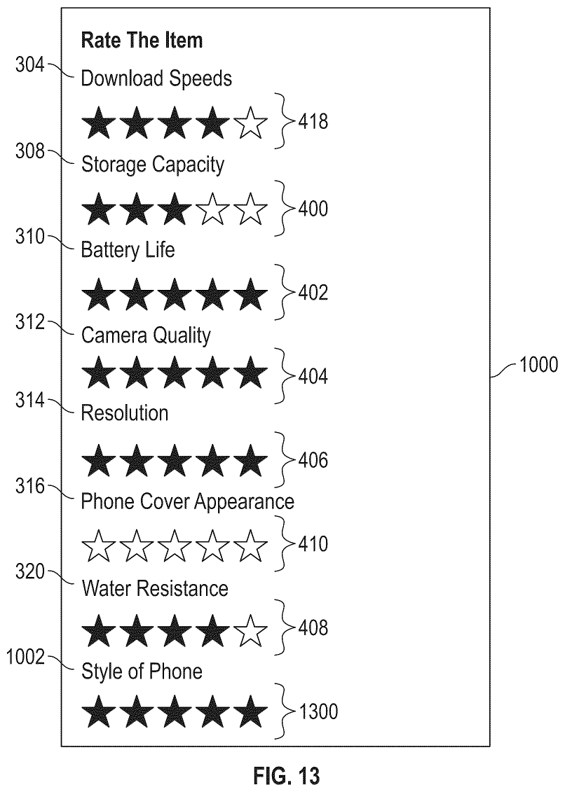

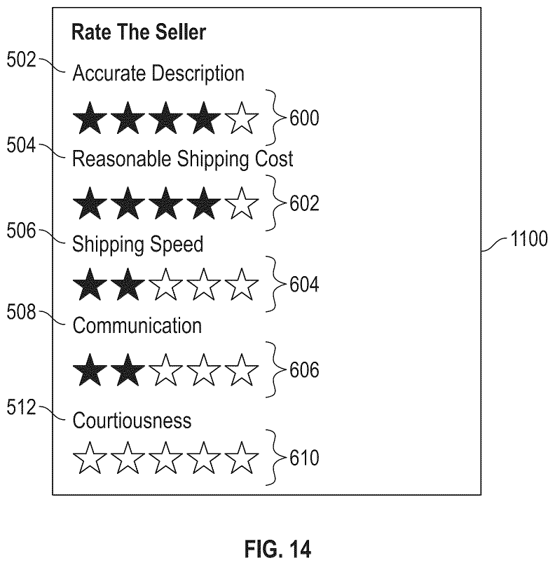

Turning attention back to the second example, during the operation 908, the server 110 receives feedback at interactive user interfaces 1000 and 1100 as shown with reference to FIGS. 13 and 14. At the interactive user interface 1000, the user 180B provided feedback for the attributes 304, 308-314, 320, and 1002. In particular, the user 180B selected three feedback response selectable elements 400 associated with the storage capacity attribute 308 while the user 180B selected five feedback response selectable elements 402 associated with the battery life attribute 310. Additionally, the user 180B selected five feedback response selectable elements 404 associated with the camera quality attribute 312 and five feedback response selectable elements 406 associated with the resolution attribute 314. The user 180B also selected four feedback response selectable elements 408 associated with the water resistance attribute 320 along with five feedback response selectable elements 1300 associated with the style of phone attribute 1002. Furthermore, the user 180B did not select the feedback response selectable element 410, which can correlate to the phone cover appearance attribute 316 having little importance to the user 180B.

In the second example, the user 180B provides feedback for the accurate description attribute 502, the reasonable shipping cost attribute 504, the shipping speed attribute 506, and the communication attribute 508 at the interactive user interface 1100. In particular, the user 180B selected four feedback response selectable elements 600 associated with the accurate description attribute 502 and four feedback response selectable elements 602 associated with the reasonable shipping cost attribute 504. Additionally, the user 180B selected two feedback response selectable elements 604 associated with the shipping speed attribute 506 and two feedback response selectable elements 606 associated with the communication attribute 508. Furthermore, the user 180B did not select any feedback response selectable elements 610, which can correlate to the attribute 512 having little importance to the user 180B. These selections are received during the operation 908.

Moreover, in the second example, the user 180B selected the selectable machine learning feedback response element 1202. Thus, during the operation 910, the server 110 receives a selection of the selectable machine learning feedback response element 1202.

In response to receiving the selection of the selectable machine learning feedback response element 1202, the machine learning model 150 accesses a first feedback, which in the second example is the feedback received during the operation 212 in the first example. During the operation 914, the machine learning model 150 can automatically generate a second feedback based on the first feedback in the first example as follows:
Yo, this mobile phone be the real deal, fam! The camera quality and the resolution are next level. The style of the phone feels legit Hollywood A-lister. They unmatched, Bro. The battery life and the camera quality are low-key off the charts! The storage capacity could be better, but it won't stop you at a party!

Returning to FIG. 9 and the method 900, after the second feedback is generated, an operation 916 can be performed where the second feedback can be provided to the user. If the user desires to make some changes to the second feedback, the user can edit the second feedback and then select the second feedback with or without the edits by selecting a pill accompanying the provided second feedback. A selection of the second feedback can be received from the user during an operation 918. During an operation 920, the second feedback can be displayed along with the selected feedback response element associated with the attribute received during the operation 908.

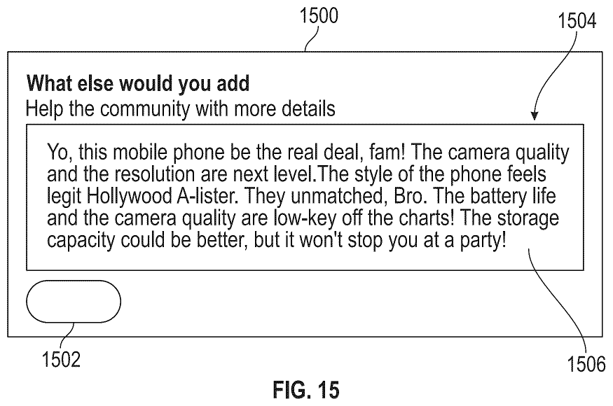

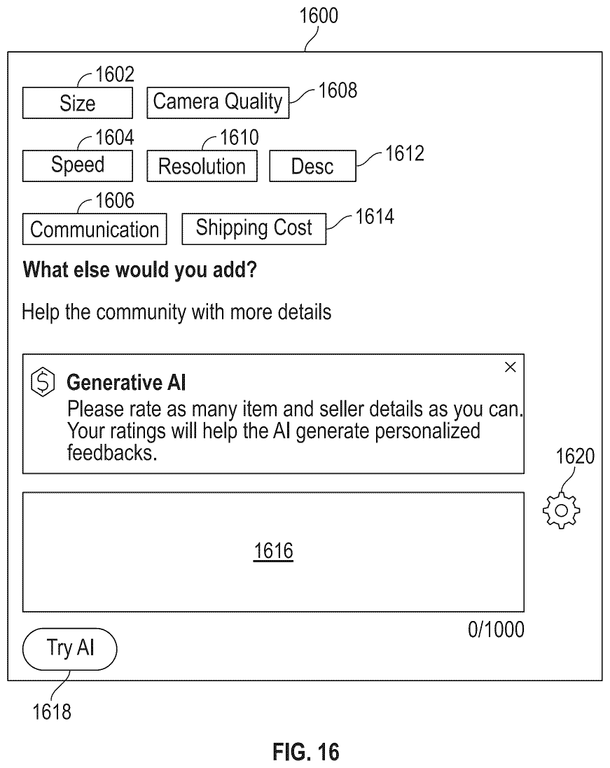

Turning attention back to the second example and FIG. 15, during the operation 916, the server 110 provides an interactive user interface 1500 that includes a pill 1502, which is selectable by the user 180B. Moreover, the interactive user interface 1500 incudes a field 1504 that displays the second feedback 1506. In the second example, the user 180B likes the second feedback and selects the pill 1502, which allows the user to accept the second feedback automatically generated. Selection of the pill is received by the server 110 and the server 110 displays the second feedback along with the attributes 304, 308-314, 320, 1002, and 502-508 and the accompanying feedback response selectable elements 400-408, 418, 600-606, and 1300 during the operation 920.

While the above description has been in the context of a user purchasing an item, examples can be expanded to cover any scenario where user feedback can be provided. To further illustrate, the present disclosure can be applied to a dating application where users can rate the operation of the dating application and the attributes can include how close the dating application presented a potential date that had personality attributes important to a user. The present disclosure can be applied in website scenarios where the interactive user interface and machine learning model feedback described above can be used to provide an interactive user interface and suggest feedback to a user based on the interaction the user had with a website. Moreover, if the user has provided feedback about an item, this can also be used to suggest feedback to the same user when purchasing a similar item or other users have purchased similar items.

The present disclosure can be applied to a messaging platform where the machine learning model 150 can learn how a user converses during messaging with another user. Here, the machine learning model 150 can be used to determine a topic of a conversation within a messaging application between first and second users, and then, using the functionality described above, suggest a message to the first user to respond to messages from the second user. To further illustrate, if the second user messages the first user about the offensive line of a football team, the machine learning model 150 can suggest a message to the first user that can be sent to the second user regarding the offensive line of the football team, such as “Yo dawg, you ain′t lying about this o-line! Their quarterback got sacked the least of any quarterback this season!” using the techniques described above.

In further examples, an interactive user interface 1600 can be provided to a user that can list pills 1602-1614. Each of the pills 1602-1614 can correspond to various attributes for a device, such as a mobile phone, where, when a user selects one of the pills, the user can provide feedback for the attribute associated with the selected pill. The attributes associated with the pills 1602-1614 can be selected as discussed above with references to the attributes 302-320, 502-512, and 1002. When a user selects one of the pills 1602-1614, a question for the attribute associated with the selected pill can be generated and displayed at an input field 1616 when the user selects a selectable machine learning feedback response element 1618. Thus, if the user selects the pill 1604 having the attribute speed and then selects the selectable machine learning feedback response element 1618, a question, such as, “does the download speed for the mobile phone allow for easy downloads when playing a game on the mobile phone?” can be presented to the user. The machine learning model 150 can generate this question based on feedback the user previously provided relating to download speeds during gaming using the techniques described above.

Moreover, the machine learning model 150 can suggest feedback if the user also selects the selectable machine learning feedback response element 1618 at the input field 1616. Thus, if a user selects the pill 1608 that corresponds with camera quality of an item, the user can be presented with the opportunity to provide feedback at the input field 1616. In addition, if the user selects the selectable machine learning feedback response element 1618, the machine learning model 150 can suggest feedback, which can be displayed at the input field 1616, as described above.

The interactive user interface 1600 can also include a functionality element 1620, which can be selectable by a user to allow the user to control the type of feedback that is recommended. To further illustrate, feedback can include different types of adjectives that can be provided with feedback, such as great, awesome, good, not very good, mediocre, or the like. regardless, the functionality element 1620 can allow users to allow for automatic customization of the feedback suggested as described herein.

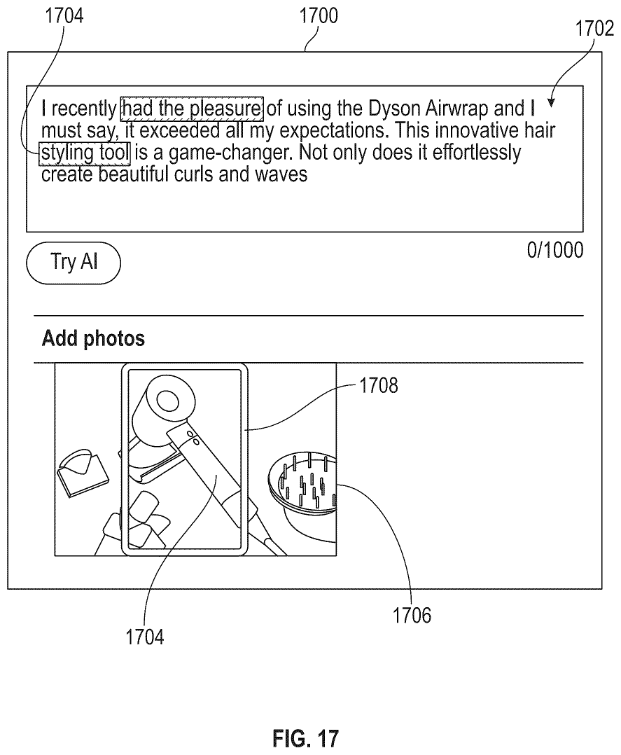

In further examples, when feedback is provided by a user, images of features of the item that are being reviewed along with an image of the device can be provided and posted. To further illustrate, a user interface 1700 can be provided that relates to a review 1702 of a device 1704, such as a styling tool. The review 1702 can be provided as discussed above, where the review 1702 can be second feedback provided by the machine learning model 150 based on a first feedback. In the review 1702, the device 1704 can be highlighted and an image 1706 of the device 1704 can be provided, as shown in FIG. 17. Moreover, the device 1704 can include highlighting 1708 that can refer to a feature of the device 1704 being discussed in the review 1702. In examples, ChatGPT can find the image from various sources, such as from the item being purchased, or third party sources, such as websites. Furthermore, an object detection application programming interface can be used to detect the image and then, in conjunction with ChatGPT, correlate the feature in the review with the feature in the image 1706.

FIG. 18 is a block diagram 1800 illustrating a software architecture 1802, which may be installed on any one or more of the devices described above. FIG. 18 is merely a non-limiting example of a software architecture, and it will be appreciated that many other architectures may be implemented to facilitate the functionality described herein. The software architecture 1802 may be implemented by hardware such as a machine 1900 of FIG. 19 that includes processors 1910, memory 1930, and I/O components 1950. In this example, the software architecture 1802 may be conceptualized as a stack of layers where each layer may provide a particular functionality. For example, the software architecture 1802 includes layers such as an operating system 1804, libraries 1806, frameworks 1808, and applications 1810. Operationally, the applications 1810 invoke application programming interface (API) calls 1812 through the software stack and receive messages 1814 in response to the API calls 1812, according to some implementations.

In various implementations, the operating system 1804 manages hardware resources and provides common services. The operating system 1804 includes, for example, a kernel 1820, services 1822, and drivers 1824. The kernel 1820 acts as an abstraction layer between the hardware and the other software layers in some implementations. For example, the kernel 1820 provides memory management, processor management (e.g., scheduling), component management, networking, and security settings, among other functionality. The services 1822 may provide other common services for the other software layers. The drivers 1824 may be responsible for controlling or interfacing with the underlying hardware. For instance, the drivers 1824 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

In some implementations, the libraries 1806 provide a low-level common infrastructure that may be utilized by the applications 1810. The libraries 1806 may include system libraries 1830 (e.g., C standard library) that may provide functions such as memory allocation functions, string manipulation functions, mathematic functions, and the like. In addition, the libraries 1806 may include API libraries 1832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 1806 may also include a wide variety of other libraries 1834 to provide many other APIs to the applications 1810.

The frameworks 1808 provide a high-level common infrastructure that may be utilized by the applications 1810, according to some implementations. For example, the frameworks 1808 provide various graphic user interface (GUI) functions, high-level resource management, high-level location services, and so forth. The frameworks 1808 may provide a broad spectrum of other APIs that may be utilized by the applications 1810, some of which may be specific to a particular operating system or platform.

In an example, the applications 1810 include a home application 1850, a contacts application 1852, a browser application 1854, a book reader application 1856, a location application 1858, a media application 1860, a messaging application 1862, a game application 1864, and a broad assortment of other applications such as a third-party application 1866. According to some examples, the applications 1810 are programs that execute functions defined in the programs. Various programming languages may be employed to create one or more of the applications 1810, structured in a variety of manners, such as object-orientated programming languages (e.g., Objective-C, Java, or C++) or procedural programming languages (e.g., C or assembly language). In a specific example, the third-party application 1866 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1866 may invoke the API calls 1812 provided by the mobile operating system (e.g., the operating system 1804) to facilitate functionality described herein.

Certain examples are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In examples, one or more computer systems (e.g., a standalone, client or server computer system) or one or more processors may be configured by software (e.g., an application or application portion) as a hardware-implemented module that operates to perform certain operations as described herein.

In various examples, a hardware-implemented module may be implemented mechanically or electronically. For example, a hardware-implemented module may include dedicated circuitry or logic that is permanently configured (e.g., as a special-purpose processor, such as a field programmable gate array (FPGA) or an application-specific integrated circuit (ASIC)) to perform certain operations. A hardware-implemented module may also include programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering examples in which hardware-implemented modules are temporarily configured (e.g., programmed), each of the hardware-implemented modules need not be configured or instantiated at any one instance in time. For example, where the hardware-implemented modules include a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses) that connects the hardware-implemented modules. In examples in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some examples, include processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some examples, the processor or processors may be located in a single location (e.g., within a home environment, an office environment or as a server farm), while in other examples, the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via the network 106 (e.g., the Internet) and via one or more appropriate interfaces (e.g., application program interfaces (APIs).)

Examples may be implemented in digital electronic circuitry, or in computer hardware, firmware, software, or in combinations of them. Examples may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers, at one site or distributed across multiple sites, and interconnected by a communication network.

The computing system can include clients and servers. A client and server are generally remote from each other and typically interact through a communication network. The relationship of client and server arises by virtue of computer programs running on the respective computers and having a client-server relationship to each other. In examples deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various examples.

FIG. 19 is a block diagram illustrating components of a machine 1900, according to some examples, able to read instructions from a machine-readable medium (e.g., a machine-readable storage medium) and perform any one or more of the methodologies discussed herein. Specifically, FIG. 19 shows a diagrammatic representation of the machine 1900 in the example form of a computer system, within which instructions 1916 (e.g., software, a program, an application, an applet, an app, or other executable code) for causing the machine 1900 to perform any one or more of the methodologies discussed herein may be executed. In alternative examples, the machine 1900 operates as a standalone device or may be coupled (e.g., networked) to other machines. In a networked deployment, the machine 1900 may operate in the capacity of a server machine or a client machine in a server-client network environment, or as a peer machine in a peer-to-peer (or distributed) network environment. The machine 1900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1916, sequentially or otherwise, that specify actions to be taken by the machine 1900. Further, while only a single machine 1900 is illustrated, the term “machine” shall also be taken to include a collection of machines 1900 that individually or jointly execute the instructions 1916 to perform any one or more of the methodologies discussed herein.

The machine 1900 may include processors 1910, memory 1930, and I/O components 1950, which may be configured to communicate with each other via a bus 1902. In an example, the processors 1910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 1912 and a processor 1914 that may execute the instructions 1916. The term “processor” is intended to include multi-core processors that may comprise two or more independent processors (also referred to as “cores”) that may execute instructions contemporaneously. Although FIG. 19 shows multiple processors, the machine 1900 may include a single processor with a single core, a single processor with multiple cores (e.g., a multi-core processor), multiple processors with a single core, multiple processors with multiple cores, or any combination thereof.

The memory 1930 may include a main memory 1932, a static memory 1934, and a storage unit 1936 accessible to the processors 1910 via the bus 1902. The storage unit 1936 may include a machine-readable medium 1938 on which are stored the instructions 1916 embodying any one or more of the methodologies or functions described herein. The instructions 1916 may also reside, completely or at least partially, within the main memory 1932, within the static memory 1934, within at least one of the processors 1910 (e.g., within the processor's cache memory), or any suitable combination thereof, during execution thereof by the machine 1900. Accordingly, in various implementations, the main memory 1932, the static memory 1934, and the processors 1910 are considered machine-readable media 1938.

As used herein, the term “memory” refers to a machine-readable medium 1938 able to store data temporarily or permanently and may be taken to include, but not be limited to, random-access memory (RAM), read-only memory (ROM), buffer memory, flash memory, and cache memory. While the machine-readable medium 1938 is shown in an example to be a single medium, the term “machine-readable medium” should be taken to include a single medium or multiple media (e.g., a centralized or distributed database, or associated caches and servers) able to store the instructions 1916. The term “machine-readable medium” shall also be taken to include any medium, or combination of multiple media, that is capable of storing instructions (e.g., instructions 1916) for execution by a machine (e.g., machine 1900), such that the instructions, when executed by one or more processors of the machine (e.g., processors 1910), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 1950 include a wide variety of components to receive input, provide output, produce output, transmit information, exchange information, capture measurements, and so on. In general, it will be appreciated that the I/O components 1950 may include many other components that are not shown in FIG. 9. The I/O components 1950 are grouped according to functionality merely for simplifying the following discussion and the grouping is in no way limiting. In various examples, the I/O components 1950 include output components 1952 and input components 1954. The output components 1952 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 1954 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further examples, the I/O components 1950 include biometric components 1956, motion components 1958, environmental components 1960, or position components 1962, among a wide array of other components. For example, the biometric components 1956 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1958 include acceleration sensor components (e.g., accelerometer), gravitation sensor components, rotation sensor components (e.g., gyroscope), and so forth. The environmental components 1960 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 1962 include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1950 may include communication components 1964 operable to couple the machine 1900 to a network 140 or devices 1970 via a coupling 1982 and a coupling 1972, respectively. For example, the communication components 1964 include a network interface component or another suitable device to interface with the network 140. In further examples, the communication components 1964 include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1970 may be another machine or any of a wide variety of peripheral devices (e.g., a peripheral device coupled via a USB).

Moreover, in some implementations, the communication components 1964 detect identifiers or include components operable to detect identifiers. For example, the communication components 1964 include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, Uniform Commercial Code Reduced Space Symbology (UCC RSS)-2D bar code, and other optical codes), acoustic detection components (e.g., microphones to identify tagged audio signals), or any suitable combination thereof. In addition, a variety of information can be derived via the communication components 1964, such as location via Internet Protocol (IP) geolocation, location via Wi-Fi® signal triangulation, location via detecting an NFC beacon signal that may indicate a particular location, and so forth.

In various examples, one or more portions of the network 140 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 140 or a portion of the network 140 may include a wireless or cellular network and the coupling 1982 may be a Code Division Multiple Access (CDMA) connection, a Global System for Mobile communications (GSM) connection, or another type of cellular or wireless coupling. In this example, the coupling 1982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In examples, the instructions 1916 are transmitted or received over the network 140 using a transmission medium via a network interface device (e.g., a network interface component included in the communication components 1964) and utilizing any one of a number of well-known transfer protocols (e.g., Hypertext Transfer Protocol (HTTP)). Similarly, in other examples, the instructions 1916 are transmitted or received using a transmission medium via the coupling 1972 (e.g., a peer-to-peer coupling) to the devices 1970. The term “transmission medium” shall be taken to include any intangible medium that is capable of storing, encoding, or carrying the instructions 1916 for execution by the machine 1900, and includes digital or analog communications signals or other intangible media to facilitate communication of such software.

Furthermore, the machine-readable medium 1938 is non-transitory (in other words, not having any transitory signals) in that it does not embody a propagating signal. However, labeling the machine-readable medium 1938 as “non-transitory”should not be construed to mean that the medium is incapable of movement; the medium should be considered as being transportable from one physical location to another. Additionally, since the machine-readable medium 1938 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific examples, various modifications and changes may be made to these examples without departing from the broader scope of examples of the present disclosure. Such examples of the inventive subject matter may be referred to herein, individually or collectively, by the term “invention” merely for convenience and without intending to voluntarily limit the scope of this application to any single disclosure or inventive concept if more than one is, in fact, disclosed.

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Such examples of the inventive subject matter may be referred to herein, individually and/or collectively, by the term “invention” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

The Abstract of the Disclosure is provided to comply with 37 C.F.R. § 1.72 (b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present disclosure as represented by the appended claims. The specification and drawings are, accordingly, to be regarded in an illustrative rather than a restrictive sense.

What is claimed is:

1. A method, comprising:
determining an occurrence of an interaction between a first user and a second user;
generating a feedback response element based on the interaction;
providing an interactive user interface, the interactive user interface listing:
the feedback response element; and
a selectable machine learning feedback response element;
receiving a selection of the selectable machine learning feedback response element from the first user;
accessing a first feedback associated with the first user in response to receiving the selection of the selectable machine learning feedback response element, the first feedback having characteristics unique to the first user;
automatically generating a second feedback using the first feedback, the second feedback incorporating the characteristics unique to the first user without input from the first user;
providing the second feedback to the first user;
receiving a selection of the second feedback from the first user; and
displaying the second feedback.

2. The method of claim 1, wherein the characteristics relate to grammar used by the first user and the second feedback incorporates the grammar used by the first user where the second feedback is automatically generated using the grammar without the input from the first user.

3. The method of claim 2, the method further comprising:
accessing information relating to the interaction; and
automatically generating the second feedback to combine the accessed information with the grammar used by the first user.

4. The method of claim 1, wherein the interaction relates to a product and the second feedback includes an aspect of the product, the method further comprising:
accessing an image displaying the product;
highlighting the product within the image; and
the interactive user interface being a first user interface, displaying the image, the highlighted product, and the second feedback on the second user interface.

5. The method of claim 1, further comprising, determining if the feedback response element has been selected, wherein the feedback response element is a first feedback response element and the method further comprises removing the first feedback response element when a determination is made when the first feedback response element has been ignored and replacing the first feedback response element with a second feedback response element different from the first feedback response element where the second feedback response element is based on the interaction.

6. The method of claim 5, wherein the interaction is the sale of a good and the first feedback response element is a first aspect of the good and the second feedback response element is a second aspect of the good different from the first aspect of the good.

7. The method of claim 1, wherein the interactive user interface is a first user interface and the interaction relates to a product, and the method further comprises:
displaying a second user interface that lists a plurality of aspects of the products listed according to a relevancy, the plurality of aspects being listed as a plurality of selectable elements on the second user interface;
receiving a selection of a selectable aspect of the plurality of selectable elements; and
generating the feedback response element to include an aspect associated with the selectable aspect of the plurality of selectable elements.

8. A non-transitory machine-readable medium having instructions embodied thereon, the instructions executable by a processor of a machine to perform operations comprising:
determining an occurrence of an interaction between a first user and a second user;
generating a feedback response element based on the interaction;
providing an interactive user interface, the interactive user interface listing:
the feedback response element; and
a selectable machine learning feedback response element;
receiving a selection of the selectable machine learning feedback response element from the first user;
accessing a first feedback associated with the first user in response to receiving the selection of the selectable machine learning feedback response element, the first feedback having characteristics unique to the first user;
automatically generating a second feedback using the first feedback, the second feedback incorporating the characteristics unique to the first user without input from the first user;
providing the second feedback to the first user;
receiving a selection of the second feedback from the first user; and
displaying the second feedback.

9. The non-transitory machine-readable medium of claim 8, wherein the characteristics relate to grammar used by the first user and the second feedback incorporates the grammar used by the first user where the second feedback is automatically generated using the grammar without the input from the first user.

10. The non-transitory machine-readable medium of claim 9, wherein the operations further comprise:
accessing information relating to the interaction; and
automatically generating the second feedback to combine the accessed information with the grammar used by the first user.

11. The non-transitory machine-readable medium of claim 8, wherein the interaction relates to a product and the second feedback includes an aspect of the product and the operations further comprise:
accessing an image displaying the product;
highlighting the product within the image; and
the interactive user interface being a first user interface, displaying the image, the highlighted product, and the second feedback on the second user interface.

12. The non-transitory machine-readable medium of claim 8, wherein the operations further comprise:
determining if the feedback response element has been selected, wherein the feedback response element is a first feedback response element; and
removing the first feedback response element when a determination is made when the first feedback response element has been ignored and replacing the first feedback response element with a second feedback response element different from the first feedback response element where the second feedback response element is based on the interaction.

13. The non-transitory machine-readable medium of claim 12, wherein the interaction is the sale of a good and the first feedback response element is a first aspect of the good and the second feedback response element is a second aspect of the good different from the first aspect of the good.

14. The non-transitory machine-readable medium of claim 8, wherein the interactive user interface is a first user interface and the interaction relates to a product and the operations further comprise:
displaying a second user interface that lists a plurality of aspects of the products listed according to a relevancy, the plurality of aspects being listed as a plurality of selectable elements on the second user interface;
receiving a selection of a selectable aspect of the plurality of selectable elements; and
generating the feedback response element to include an aspect associated with the selectable aspect of the plurality of selectable elements.

15. A device, comprising:
a processor; and
memory including instructions that, when executed by the processor, cause the device to perform operations including:
determining an occurrence of an interaction between a first user and a second user;
generating a feedback response element based on the interaction;
providing an interactive user interface, the interactive user interface listing:
the feedback response element; and
a selectable machine learning feedback response element;
receiving a selection of the selectable machine learning feedback response element from the first user;
accessing a first feedback associated with the first user in response to receiving the selection of the selectable machine learning feedback response element, the first feedback having characteristics unique to the first user;
automatically generating a second feedback using the first feedback, the second feedback incorporating the characteristics unique to the first user without input from the first user;
providing the second feedback to the first user;
receiving a selection of the second feedback from the first user; and
displaying the second feedback.

16. The device of claim 15, wherein the characteristics relate to grammar used by the first user and the second feedback incorporates the grammar used by the first user where the second feedback is automatically generated using the grammar without the input from the first user, wherein the operations further comprise:
accessing information relating to the interaction; and
automatically generating the second feedback to combine the accessed information with the grammar used by the first user.

17. The device of claim 15, wherein the interaction relates to a product and the second feedback includes an aspect of the product and the operations further comprise:
accessing an image displaying the product;
highlighting the product within the image; and
the interactive user interface being a first user interface, displaying the image, the highlighted product, and the second feedback on the second user interface.

18. The device of claim 15, wherein the operations further comprise:
determining if the feedback response element has been selected, wherein the feedback response element is a first feedback response element; and
removing the first feedback response element when a determination is made when the first feedback response element has been ignored and replacing the first feedback response element with a second feedback response element different from the first feedback response element where the second feedback response element is based on the interaction.

19. The device of claim 18, wherein the interaction is the sale of a good and the first feedback response element is a first aspect of the good and the second feedback response element is a second aspect of the good different from the first aspect of the good.

20. The device of claim 15, wherein the interactive user interface is a first user interface and the interaction relates to a product and the operations further comprise:
displaying a second user interface that lists a plurality of aspects of the products listed according to a relevancy, the plurality of aspects being listed as a plurality of selectable elements on the second user interface;
receiving a selection of a selectable aspect of the plurality of selectable elements; and
generating the feedback response element to include an aspect associated with the selectable aspect of the plurality of selectable elements.
